(19) United States
(12) Patent Application Publication
(10) Pub. No.: US 2018/0224145 A1
(43) Pub. Date: Aug. 9, 2018

(54) AIR-CONDITIONING SYSTEM AND CARBON DIOXIDE ABSORBING UNIT

(71) Applicant: SHARP KABUSHIKI KAISHA, Sakai City, Osaka (JP)

(72) Inventors: HIDEHARU TAJIMA, Sakai City (JP); TAKAYUKI NAKA, Sakai City (JP); HIROHISA YAMADA, Sakai City (JP)

(21) Appl. No.: 15/746,577

(22) PCT Filed: Jul. 8, 2016
(86) PCT No.: PCT/JP2016/070216

§ 371 Date: Jan. 22, 2018

(30) Foreign Application Priority Data
Jul. 27, 2015 (JP) 2015-148103

(51) Int. Cl. F24F 11/30; F24F 3/14; F24F 3/16; F24F 11/72; F24F 11/81; B01D 53/14; B01D 53/18

(52) U.S. Cl. CPC F24F 11/30; F24F 3/14; F24F 3/1603; F24F 11/72; F24F 11/81; F24F 2110/70; B01D 53/18; B01D 2257/504; F24F 2003/1614; F24F 2003/1657; B01D 53/1412

(57) ABSTRACT

At least one of temperature and humidity is appropriately adjusted and CO₂ concentration in the air is adjusted to an appropriate value. An air-conditioning system (100) includes a CO₂ concentration detection portion (13), a CO₂ absorbing unit (40) that absorbs CO₂ from the air which has been taken via flow paths a and b or a flow path c and thereafter discharges the air to the flow path via which the air has been taken, and a CO₂ concentration control portion (25) that adjusts, in accordance with the CO₂ concentration, an amount of the air to be taken.

### TECHNICAL FIELD

The present invention relates to an air-conditioning system that controls concentration of carbon dioxide in the air.

### BACKGROUND ART

From a viewpoint of a problem of environmental pollution such as air pollution due to PM (Particulate Matter) 2.5 or increased awareness of power saving of people, necessity for increasing sealability of an inside of a room of a residential house, an office, or the like has been grown. On the other hand, when the sealability in the room is increased, concentration of carbon dioxide (CO₂) in the air in the room increases, so that a bad influence may be given on a human body. For example, when the concentration of CO₂ in the room is about 1000 ppm, a person loses concentration or feels sleepiness. In order to avoid such a bad influence, the Labor Standards Act regulates, in the case of an inside of an office, concentration of CO₂ in the air to be kept in a specific range.

As a technique for adjusting the concentration of CO₂ in the room, a technique is developed that a discharge port and an air supply port are provided in the room, the air from the discharge port is subjected to temperature adjustment, and CO₂ caused to be absorbed by activated carbon, thereby removing CO₂ in the air (PTL 1 described below).

### CITATION LIST

### Patent Literature

PTL 1: Japanese Unexamined Patent Application Publication No. 2001-317780 (published on Nov. 16, 2001)

### SUMMARY OF INVENTION

### Technical Problem

However, an air flow rate optimum for temperature adjustment and an air flow rate optimum for adjustment of the concentration of CO₂ are not necessarily equal to each other. Thus, with a CO₂ removing method disclosed in PTL 1, when the air flow rate is set to be appropriate for the temperature adjustment, adjustment of an absorption amount of CO₂ may be not allowed or may become difficult. In particular, when there is fluctuation in the number of persons in the room where the concentration of CO₂ is to be adjusted, it becomes difficult to adjust the concentration of CO₂ in the air to an appropriate value. That is, in the conventional technique, it is difficult to simultaneously achieve both of appropriate adjusting at least one of temperature and humidity and adjusting the concentration of CO₂ in the air to an appropriate value.

The invention of the present application was made in view of the aforementioned problems and an object thereof is to provide an air-conditioning system and a CO₂ absorbing unit that are able to appropriately adjust at least one of temperature and humidity and adjust concentration of CO₂ in the air to an appropriate value.

### Solution to Problem

In order to solve the aforementioned problems, an air-conditioning system according to an aspect of the invention is an air-conditioning system that includes an air-conditioning unit that adjusts at least one of temperature and humidity in air, a first flow path through which air in a space is introduced to the air-conditioning unit, and a second flow path through which air discharged from the air-conditioning unit is introduced to the space. The air-conditioning system includes a CO₂ concentration detection portion that detects CO₂ concentration of the air in the space; a CO₂ absorbing unit that absorbs CO₂ from air which has been taken via the first flow path or the second flow path and thereafter discharges the air to the flow path via which the air is taken; and a flow rate control portion that adjusts, in accordance with the CO₂ concentration detected by the CO₂ concentration detection portion, an amount of air to be taken into the CO₂ absorbing unit.

Moreover, in order to solve the aforementioned problems, a CO₂ absorbing unit according to an aspect of the invention is a CO₂ absorbing unit added to an air-conditioning system including an air-conditioning unit that adjusts at least one of temperature and humidity of air in a space and discharges the air to the space. The CO₂ absorbing unit includes a CO₂ absorbing portion that contains a CO₂ absorbing member absorbing CO₂ in air. In the CO₂ absorbing unit, a flow rate of air to be taken into the CO₂ absorbing portion via either a first flow path through which the air in the space is introduced to the air-conditioning unit or a second flow path through which air discharged from the air-conditioning unit is introduced to the space is controlled by a flow rate control portion, which is included in the air-conditioning system, in accordance with CO₂ concentration detected by a CO₂ concentration detection portion that is included in the air-conditioning system.

### Advantageous Effects of Invention

According to an aspect of the invention, it is possible to appropriately adjust at least one of temperature and humidity and adjust concentration of CO₂ in the air to an appropriate value.

### BRIEF DESCRIPTION OF DRAWINGS

FIG. 1 illustrates a configuration of a main part of an air-conditioning system according to Embodiment 1 of the invention.

FIG. 2 illustrates a configuration of a CO₂ absorbing unit of the air-conditioning system.

FIG. 3 illustrates a configuration of a CO₂ absorbing portion included in the CO₂ absorbing unit.

FIG. 4 is a flowchart indicating an air-conditioning control method in the air-conditioning system.

FIG. 5 illustrates another example of a configuration of the air-conditioning system.

FIG. 6 illustrates still another example of the configuration of the air-conditioning system.

### DESCRIPTION OF EMBODIMENTS

### Embodiment 1

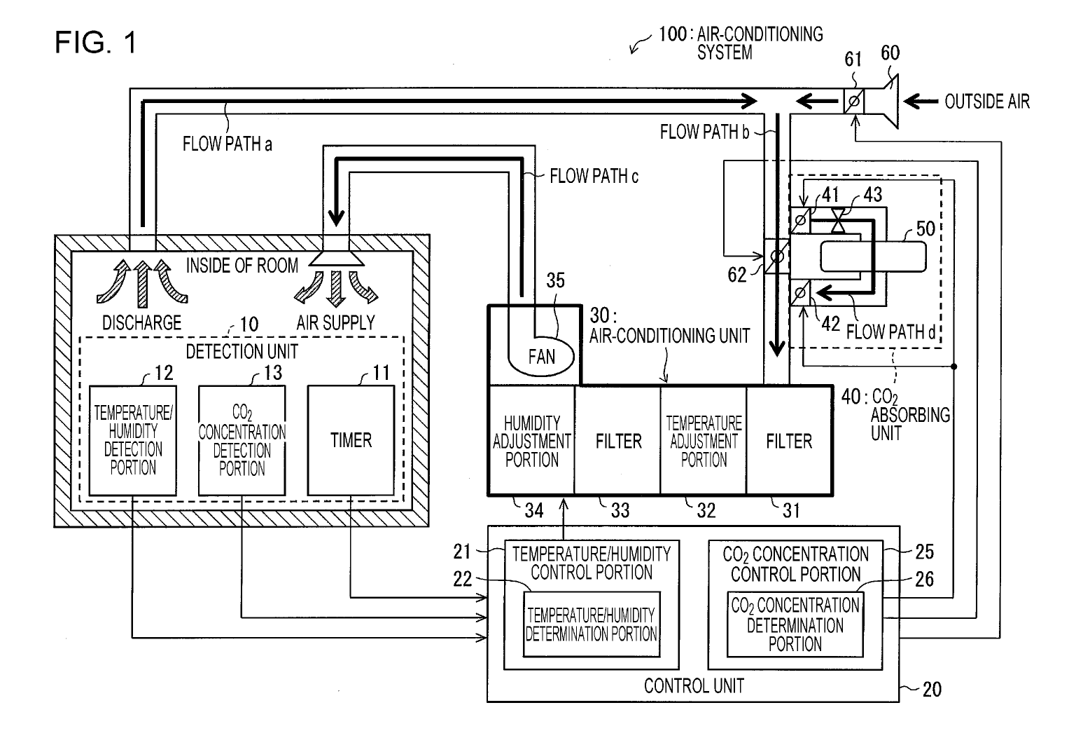

A first embodiment of the invention will be described below with reference to FIGS. 1 to 4. First, a configuration of a main part of an air-conditioning system 100 according to the present embodiment will be described with reference to FIG. 1. FIG. 1 illustrates the configuration of the main part of the air-conditioning system 100 according to the present embodiment.

### <<Configuration of Main Part of Air-Conditioning System 100>>

The air-conditioning system 100 is a system for performing air-conditioning control for an inside of a room. In the present embodiment, the “inside of a room” refers to an inside of a space of a subject in which concentration of CO₂ is to be controlled by the air-conditioning system 100 and a space where air exists, predetermined sealing is allowed, and living things are active. As an example, the inside of the room indicates a living space in a residence (in particular, a residence having a highly airtight structure), a working space in a plant, an office, or the like, and a space in a means of transportation such as an automobile, a train, an airplane, and a ship. Note that, the “space where predetermined sealing is allowed” indicates a space that is able to increase sealability by using its functions and operations (for example, closing a window or a door, or operating a device that pressurizes a room, such as a fan that suppresses an operation of a ventilating fan is able to be performed) and a space that structurally has relatively high sealability such as a residence having a highly airtight structure.

The air-conditioning system 100 includes a detection unit 10, a control unit 20, an air-conditioning unit 30, and a CO₂ absorbing unit 40. Note that, in the following description, air of the inside of the room is simply referred to as “air” and the air introduced from an outside of the room is referred to as “outside air” unless otherwise noted. As illustrated in the figure, the air-conditioning system 100 is provided with a flow path a (first flow path) through which the air discharged from the inside of the room passes, a flow path b (first flow path) through which the air from the flow path a (and the air from a ventilation opening 60) is introduced to the air-conditioning unit 30, and a flow path c (second flow path) through which the air discharged from the air-conditioning unit 30 is introduced to the inside of the room. Note that, as illustrated in the figure, the air-conditioning system 100 may be provided with the ventilation opening 60 through which the outside air is taken and an outside air flow rate controller 61 that controls a flow rate of the outside air. Further, in the air-conditioning system 100, a branching flow rate controller 62 that controls a flow rate of the air to a flow path d is provided in the middle of the flow path b and the CO₂ absorbing unit 40 is connected so as to hold a front part and a rear part of the branching flow rate controller 62. The flow path d (a third flow path and a fourth flow path) for the air passing through a CO₂ absorbing portion described below is formed in the CO₂ absorbing unit 40.

In other words, in the air-conditioning system 100, the air discharged from the inside of the room passes through the flow path a, is mixed with the outside air as necessary, and passes through the flow path b. At this time, a part or all of the air passing through the flow path b goes through the flow path d in accordance with control of the branching flow rate controller 62. Then, after passing through the air-conditioning unit 30, the air passes through the flow path c and is returned to the inside of the room.

The air-conditioning system 100 according to the invention includes a CO₂ concentration adjustment portion that is provided in the middle of a flow path of at least either the flow paths a and b (first flow path) or the flow path c (second flow path) in order to introduce, into the inside of the room, the air at least one of temperature and humidity of which is appropriately adjusted and CO₂ concentration of which is appropriately adjusted, adjusts CO₂ concentration of the air passing through the flow path in accordance with the CO₂ concentration in the inside of the room, and discharges the adjusted air to the flow path. The CO₂ concentration adjustment portion is realized by the CO₂ absorbing unit 40 and the control unit 20 which are described above.

### (Detection Unit 10)

Next, the configuration of the main part of the air-conditioning system 100 will be described more specifically. The detection unit 10 includes a timer 11, a temperature/humidity detection portion 12, and a CO₂ concentration detection portion 13. The timer 11 measures a time and notifies the control unit 20 of the time at any time. The temperature/humidity detection portion 12 detects temperature and humidity in accordance with an instruction from the control unit 20 and transmits detection values to the control unit 20. The CO₂ concentration detection portion 13 detects CO₂ concentration in the air in accordance with an instruction from the control unit 20, and transmits a detection value to the control unit 20. The CO₂ concentration detection portion 13 is able to be realized by, for example, a CO₂ sensor of an infrared or electrolyte type or the like. Note that, the detection unit 10 is provided in the inside of the room in FIG. 1, but may be provided, for example, on an upstream side of the branching flow rate controller 62 of the flow path a or the flow path b. The timer 11, the temperature/humidity detection portion 12, and the CO₂ concentration detection portion 13 may be separately provided at different places.

### (Control Unit 20)

The control unit 20 receives the detection values from the temperature/humidity detection portion 12 and the CO₂ concentration detection portion 13 of the detection unit 10, and controls operations of the air-conditioning unit 30 and the CO₂ absorbing unit 40 in accordance with the detection values. The control unit 20 includes a temperature/humidity control portion 21 and a CO₂ concentration control portion (flow rate control portion) 25, and when a measurement time received from the timer 11 reaches a predetermined time, the control unit 20 causes the temperature/humidity detection portion 12 to detect temperature and humidity and causes the CO₂ concentration detection portion 13 to detect the CO₂ concentration, and receives detection values thereof.

The temperature/humidity control portion 21 controls the air-conditioning unit 30 in accordance with the detection values of the temperature/humidity detection portion 12. The temperature/humidity control portion 21 includes a temperature/humidity determination portion 22. When the temperature/humidity control portion 21 receives the detection values (information indicating the temperature and the humidity) from the temperature/humidity detection portion 12, the temperature/humidity determination portion 22 determines whether or not the temperature and the humidity are respectively in predetermined ranges of temperature and humidity that are set. When the temperature/humidity determination portion 22 determines that the temperature of the temperature and the humidity is out of the predetermined range of temperature, the temperature/humidity control portion 21 instructs the air-conditioning unit 30 to adjust the temperature. More specifically, when the temperature/humidity determination portion 22 determines that the temperature is lower than the predetermined range, the temperature/humidity control portion 21 instructs the air-conditioning unit 30 to increase the temperature of the air passing through the air-conditioning unit 30, and when the temperature/humidity determination portion 22 determines that the temperature is higher than the predetermined range, the temperature/humidity control portion 21 instructs the air-conditioning unit 30 to decrease the temperature of the air passing through the air-conditioning unit 30.

When the temperature/humidity determination portion 22 determines that the humidity, in the temperature and the humidity, is out of the predetermined range of humidity, the temperature/humidity control portion 21 instructs the air-conditioning unit 30 to adjust the humidity. More specifically, when the temperature/humidity determination portion 22 determines that the humidity is lower than the predetermined range, the temperature/humidity control portion 21 instructs the air-conditioning unit 30 to increase the humidity, and when the temperature/humidity determination portion 22 determines that the humidity is higher than the predetermined range, the temperature/humidity control portion 21 instructs the air-conditioning unit 30 to decrease the humidity.

When the temperature/humidity determination portion 22 determines that both the temperature and the humidity are out of the predetermined ranges of temperature and humidity, the temperature/humidity control portion 21 instructs the air-conditioning unit 30 to adjust the temperature and adjust the humidity. When the temperature/humidity determination portion 22 determines that both the temperature and the humidity are in the predetermined ranges, the temperature/humidity control portion 21 does not give any instruction to the air-conditioning unit 30 or transmits only an instruction to operate a fan 35 described below.

Note that, the predetermined ranges of temperature and humidity are ranges of temperature and humidity, with which a person in the inside of the room is able to spend a comfortable time, for example. The predetermined ranges of temperature and humidity may be values that are able to be freely set by a user of the air-conditioning system 100.

The CO₂ concentration control portion 25 controls the CO₂ absorbing unit 40 in accordance with the detection value of the CO₂ concentration detection portion 13. The CO₂ concentration control portion 25 includes a CO₂ concentration determination portion 26. When the CO₂ concentration control portion 25 receives the detection value (information indicating the CO₂ concentration in the air) from the CO₂ concentration detection portion 13, the CO₂ concentration determination portion 26 determines whether or not the CO₂ concentration in the air is equal to or greater than predetermined concentration that is set in advance. Here, the predetermined concentration is an upper limit (for example, 1000 ppm or the like) of CO₂ concentration that does not give a bad influence on a human body. Note that, the predetermined concentration may be a value that is able to be freely set by the user of the air-conditioning system 100. When the CO₂ concentration determination portion 26 determines that the CO₂ concentration in the air is equal to or greater than the predetermined concentration, the CO₂ concentration control portion 25 instructs the CO₂ absorbing unit 40 to absorb CO₂ in the air.

More specifically, the instruction includes information for prescribing degree of opening (opening areas) of movable valves of an introduced air volume controller 41 (described below) and a discharged air volume controller 42 (described below) of the CO₂ absorbing unit 40. For example, when the CO₂ concentration determination portion 26 determines that the CO₂ concentration in the air is much greater than the predetermined concentration, the CO₂ concentration control portion 25 transmits, to the CO₂ absorbing unit 40, an instruction to maximize the opening areas of the movable valves of the introduced air volume controller 41 and the discharged air volume controller 42. Thereby, the air of the flow path b flows to the flow path d at a maximum and absorbing of CO₂ by a CO₂ absorbing portion 50 described below is performed at a maximum. On the other hand, when the CO₂ concentration determination portion 26 determines that the CO₂ concentration in the air is slightly greater than the predetermined concentration, the CO₂ concentration control portion 25 sets the opening areas of the introduced air volume controller 41 and the discharged air volume controller 42 to be smaller than the maximum areas and thereby restricts the volume of the air flowing to the flow path d. This makes it possible to prevent the CO₂ in the air from being excessively absorbed. Note that, a correspondence relation of the CO₂ concentration in the air and the opening areas of the introduced air volume controller 41 and the discharged air volume controller 42, which is described above, is merely an example and the correspondence relation may be set as appropriate.

Further, the CO₂ concentration control portion 25 may control the branching flow rate controller 62 to open a movable valve of the branching flow rate controller 62 with an opening area according to the degree of opening of the movable valves of the introduced air volume controller 41 and the discharged air volume controller 42 described above.

On the other hand, when the detection value is less than the predetermined concentration, the CO₂ concentration control portion 25 causes the CO₂ absorbing unit 40 to open the movable valve of the branching flow rate controller 62. At this time, the CO₂ concentration control portion 25 transmits an instruction to open the movable valve of the discharged air volume controller 42 described below or does not transmit any instruction to the CO₂ absorbing unit 40.

### (Air-Conditioning Unit 30)

The air-conditioning unit 30 is a device that adjusts temperature and humidity in the air. The air-conditioning unit 30 includes filters 31 and 33, a temperature adjustment portion 32, a humidity adjustment portion 34 that adjusts humidity in the air, and the fan 35. The filters 31 and 33 are filters for removing dust or the like in the air that has passed through the flow path b. Note that, the air-conditioning unit 30 may be a unit that adjusts any one of temperature and humidity. The air-conditioning unit 30 may include an outdoor machine or the like to adjust temperature or humidity.

The temperature adjustment portion 32 serves as a heating coil and a cooling coil that adjust temperature of the air. The temperature adjustment portion 32 heats the air by operating the heating coil when the instruction of temperature control that is received by the air-conditioning unit 30 from the control unit 20 is an instruction to increase the temperature of the air passing through the air-conditioning unit 30, and cools the air by operating the cooling coil when it is an instruction to decrease the temperature of the air passing through the air-conditioning unit 30. Thereby, the temperature of the air flowing from the flow path b to the air-conditioning unit 30 becomes temperature in the predetermined range or is made much closer to the temperature in the predetermined range.

More specifically, the humidity adjustment portion 34 serves as a dehumidifier and a humidifier. The humidity adjustment portion 34 increases the humidity of the air by operating the humidifier when the instruction of humidity control that is from the control unit 20 is an instruction to increase the humidity, and decreases the humidity in the air by operating the dehumidifier when it is an instruction to decrease the humidity. Thereby, the humidity of the air flowing from the flow path b to the air-conditioning unit 30 becomes humidity in the predetermined range or is made much closer to the humidity in the predetermined range.

The air that has passed through the flow path b and has been introduced to the air-conditioning unit 30 passes through the filter 31, the temperature adjustment portion 32, the filter 33, and the humidity adjustment portion 34. Note that, the order in which the air passes through each of the portions is not particularly limited and the filter 31 or 33 is not an essential component. The air that has passed through each of the aforementioned portions of the air-conditioning unit 30 is discharged to the flow path c finally via the fan 35. Thereby, the air passing through the air-conditioning unit 30 has the temperature and the humidity adjusted to be the temperature and the humidity in the predetermined ranges (or closer to the predetermined ranges), and is supplied to the inside of the room via the flow path c.

The fan 35 sends, to the flow path c, the air that has passed through an inside of the air-conditioning unit 30. The fan 35 may be caused to operate or stop in accordance with the instruction received from the control unit 20 by the air-conditioning unit 30, or may be caused to operate continuously.

### (CO₂ Absorbing Unit 40)

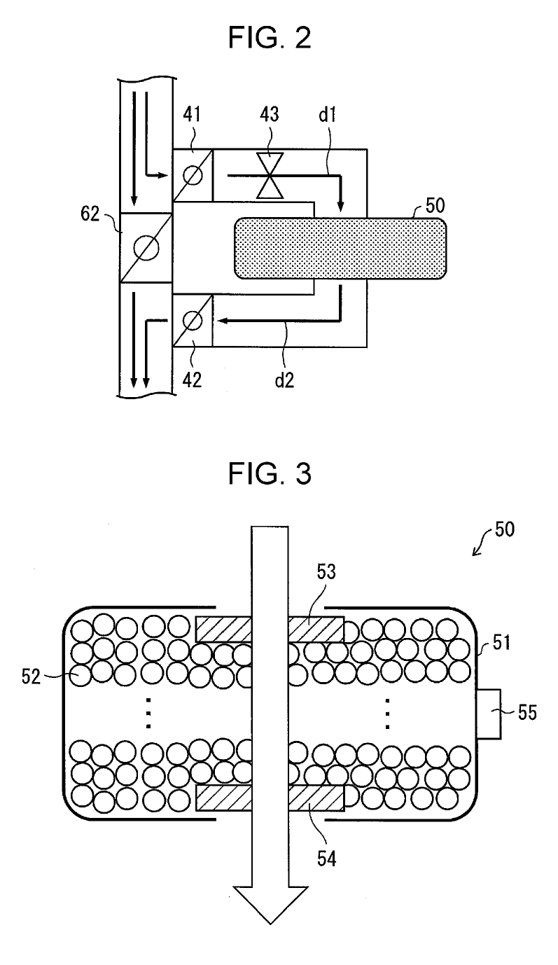

The CO₂ absorbing unit 40 is a device that decreases the CO₂ concentration in the air by causing the air to pass through a CO₂ absorbing member (CO₂ absorbing pellet 52 described below). Hereinafter, a configuration of the Co₂ absorbing unit 40 will be described by using FIG. 2. FIG. 2 illustrates the configuration of the CO₂ absorbing unit 40. As illustrated, the CO₂ absorbing unit 40 includes the introduced air volume controller 41, the discharged air volume controller 42 and the CO₂ absorbing portion 50. Note that, as illustrated, in the flow path d, a flow path of an upstream of the CO₂ absorbing unit 50 (described below) and a flow path of a downstream thereof are hereinafter referred to as a flow path d1 (third flow path) and a flow path d2 (fourth flow path), respectively.

The introduced air volume controller 41 controls a flow rate of the air that is introduced to the CO₂ absorbing unit 40 and a flow rate of the air that passes through the branching flow rate controller 62, and is provided at a branch point of the CO₂ absorbing unit 40 and the flow path b. More specifically, the introduced air volume controller 41 has the movable valve that is able to control the flow rate of the air by the opening area, and the movable valve is controlled in accordance with control of the CO₂ concentration control portion 25 of the control unit 20. By controlling the opening area of the introduced air volume controller 41 and the opening area of the branching flow rate controller 62, it is possible to adjust an amount of the air that passes through the branching flow rate controller 62 and an amount of the air that passes through the flow path d.

The discharged air volume controller 42 controls a flow rate of the air that is discharged from the CO₂ absorbing unit 40, and is provided at a branch point of the CO₂ absorbing unit 40 and the flow path b and in a downstream of a connection part of the flow path d1 with respect to the flow path b. Similarly to the introduced air volume controller 41, the discharged air volume controller 42 also has the movable valve that is able to control the flow rate of the air by the opening area, and the movable valve is controlled in accordance with control of the CO₂ concentration control portion 25 of the control unit 20. More specifically, the opening area of the movable valve of the discharged air volume controller 42 is controlled in accordance with the opening area of the movable valve of the introduced air volume controller 41 so that a flow of the air in each of the flow path b and the flow path d is not prevented. When an inflow of the air to the flow path d1 is 0 (that is, a state where the movable valve of the introduced air volume controller 41 is closed), the movable valve of the discharged air volume controller 42 is closed so that the air that has passed through the branching flow rate controller 62 does not flow backward to the flow path d2.

The CO₂ absorbing unit 40 is connected to the middle of the flow path b in such a manner that the front part and the rear part of the branching flow rate controller 62 is held by the introduced air volume controller 41 and the discharged air volume controller 42 of the CO₂ absorbing unit 40. The CO₂ absorbing unit 40 adjusts the opening areas of the introduced air volume controller 41 and the discharged air volume controller 42 in accordance with a control instruction of the CO₂ concentration received from the control unit 20.

Note that, although the CO₂ absorbing unit 40 is connected to the flow path b in the example of FIG. 1, the CO₂ absorbing unit 40 may be connected to the middle of a flow path (flow path c) through which the air which is discharged from the air-conditioning unit 30 (that is, in which the temperature and the humidity have been adjusted) is returned to the inside of the room. Moreover, as illustrated, the CO₂ absorbing unit 40 may be provided with a fan 43 that makes good a pressure loss generated in the CO₂ absorbing portion 50. When the fan 43 is provided, a flow rate of the air in the entirety of the air-conditioning system 100 is able to be similar to a flow rate of the air in a case where the CO₂ absorbing unit 40 is not provided (that is, such a case that only adjustment of the temperature and the humidity of the air is performed by the air-conditioning unit 30). It is therefore possible to realize an adjustment function of the temperature and the humidity by the air-conditioning unit 30 with performance similar to that of a case where the CO₂ absorbing unit 40 is not provided.

### (Configuration of CO₂ Absorbing Portion)

The CO₂ absorbing portion 50 will be described here more specifically by using FIG. 3. FIG. 3 illustrates a configuration of the CO₂ absorbing portion 50 included in the CO₂ absorbing unit 40. Note that, an arrow in the figure indicates a direction in which the air flows. As illustrated, the CO₂ absorbing portion 50 includes the CO₂ absorbing pellet (CO₂ absorbing member) 52 and a filter cover 51. Furthermore, the filter cover 51 is provided with a replacement port 55, an inflow hole 53, and a discharge hole 54.

The filter cover 51 contains and holds the CO₂ absorbing pellet 52. A material and a shape of the filter cover 51 are not limited in particular as long as being able to hold the CO₂ absorbing pellet 52 so as to be isolated from the air other than from the inflow hole 53 and the discharge hole 54. The replacement port 55 provided in the filter cover 51 is an opening portion for replacement of the CO₂ absorbing pellet 52 and is designed so as to be freely opened/closed.

The inflow hole 53 is a hole through which the air that flows from the flow path d1 is taken into an inside of the filter cover 51 to be introduced to the CO₂ absorbing pellet 52. Note that, in order to prevent dust in the flow path d1 from entering the filter cover 51 and adhering to the CO₂ absorbing pellet 52, it is desired that a dustproof filter is provided in the inflow hole 53. The discharge hole 54 is a hole through which the air CO₂ of which has been absorbed (the air in which the CO₂ concentration has been decreased) is discharged to the flow path d2. Note that, in order to prevent a broken piece of the CO₂ absorbing pellet 52 or the like from being discharged to the flow path d2, it is desired that a dustproof filter is provided in the discharge hole 54.

The CO₂ absorbing pellet 52 is a CO₂ absorbing member that absorbs or adsorbs CO₂ included in the air supplied from the inflow hole 53. A material of the CO₂ absorbing pellet 52 is not limited in particular as long as, during a period until the air that has flowed from the inflow hole 53 is discharged from the discharge hole 54, being able to absorb CO₂ in the air. However, it is desired that the material of the CO₂ absorbing pellet 52 is able to absorb CO₂ in the air at normal temperature (for example, 15 to 28° C.) and normal pressure. Moreover, it is desired that the material of the CO₂ absorbing pellet 52 is able to absorb CO₂ of low concentration (for example, equal to or less than 1000 ppm) at a comparatively high speed (during the period until the air that has flowed from the inflow hole 53 is discharged from the discharge hole 54). As above, in a case of being able to absorb CO₂ at the normal temperature and the normal pressure and in a case of being able to absorb CO₂ at the high speed, it is possible to reduce energy (for heating or pressurizing the CO₂ absorbing pellet 52 or the like) which is required for absorbing CO₂. Examples of the material that satisfies such desired conditions include a lithium composite oxide such as Li₂ZrO₃, LiFeO₂, LiNiO₂, Li₂TiO₃, Li₂SiO₃, or Li₄SiO₄.

Note that, the CO₂ absorbing unit 40 is not limited to adopt a particle-filling method in which the inside of the filter cover 51 is filled with the CO₂ absorbing pellet 52 and the air is caused to pass through the CO₂ absorbing pellet as described above. Moreover, routes and shapes of the flow paths d1 and d2 are not limited to the routes and the shapes in FIG. 1, either. For example, for the CO₂ absorbing portion 50, a module filling method in which the CO₂ absorbing member is supported by a nonwoven fabric or the like, a honeycomb-shaped filter method in which the CO₂ absorbing member is applied to a base material having a honeycomb structure, or the like may be adopted.

### <<Air-Conditioning Control Method in Air-Conditioning System 100>>

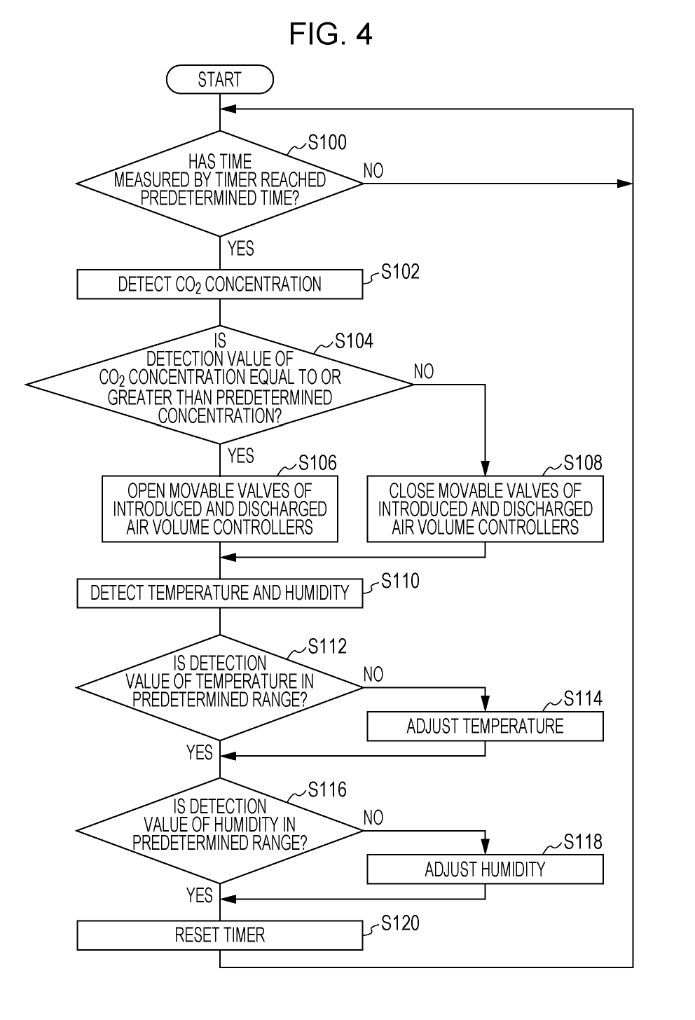

Lastly, a method of air-conditioning control (air-conditioning control method) in the air-conditioning system 100 will be described by using FIG. 4. FIG. 4 is a flowchart indicating the air-conditioning control method in the air-conditioning system 100.

In the air-conditioning system 100, the timer 11 of the detection unit 10 measures a time and transmits a measurement result to the control unit 20 at any time. The control unit 20 determines whether or not a measurement time of the timer 11 has reached a predetermined time (S100). In a case where the measurement time of the timer 11 has reached the predetermined time (YES at S100), the control unit 20 instructs the temperature/humidity detection portion 12 to detect temperature and humidity and the CO₂ concentration detection portion 13 to detect CO₂ concentration

When receiving the instruction from the control unit 20, the CO₂ concentration detection portion 13 detects the CO₂ concentration in the air (S102), and transmits a detection value to the CO₂ concentration control portion 25 of the control unit 20. The CO₂ concentration determination portion 26 of the CO₂ concentration control portion 25 determines whether or not the detection value of the CO₂ concentration is equal to or greater than predetermined concentration (S104). In a case where the detection value of the CO₂ concentration is equal to or greater than the predetermined concentration (YES at S104), the CO₂ concentration control portion 25 instructs the CO₂ absorbing unit 40 to absorb CO₂ in the air. On the basis of a prescription of the instruction, the CO₂ absorbing unit 40 causes the movable valves of the introduced air volume controller 41 and the discharged air volume controller 42 to open (S106) and adjusts the opening areas thereof to thereby adjust an amount of the air that passes through the CO₂ absorbing portion 50. Moreover, the CO₂ concentration control portion 25 may control the movable valve of the branching flow rate controller 62 to have the opening area according to the opening areas of the movable valves of the introduced air volume controller 41 and the discharged air volume controller 42. As a result, the air that has passed through the flow path d in FIG. 1 (that has passed through the CO₂ absorbing portion 50) and the air that has passed through the branching flow rate controller 62 in the flow path b are mixed, and thereby the air the CO₂ concentration of which is adjusted flows into the air-conditioning unit 30.

Note that, in a case where the detection value of the CO₂ concentration is less than the predetermined concentration (NO at S104), it is not necessary to adjust the CO₂ concentration in the air, so that the CO₂ concentration control portion 25 transmits, to the CO₂ absorbing unit 40, an instruction to close the introduced air volume controller 41 and the discharged air volume controller 42. In this case, the movable valve of the branching flow rate controller 62 may be fully opened. The CO₂ absorbing unit 40 closes the movable valves of the introduced air volume controller 41 and the discharged air volume controller 42 in accordance with the instruction (S108). It is thereby possible to prevent the air from flowing into the flow path d from the flow path b, thus making it possible to prevent CO₂ from being absorbed by the CO₂ absorbing portion 50. Moreover, it is possible to prevent the air that has passed through the branching flow rate controller 62 from flowing backward to the flow path d.

On the other hand, when receiving the instruction from the control unit 20, the temperature/humidity detection portion 12 detects temperature and humidity (S110), and transmits detection values to the temperature/humidity control portion 21. The temperature/humidity determination portion 22 of the temperature/humidity control portion 21 determines whether or not the detection value of the temperature is in a predetermined range of temperature (S112). In a case where the detection value of the temperature exceeds the predetermined range of temperature (NO at S112), the temperature/humidity control portion 21 instructs the air-conditioning unit 30 to adjust the temperature, and the air-conditioning unit 30 causes the temperature adjustment portion 32 to operate and thereby adjusts the temperature to be in the predetermined range of temperature (S114). Note that, in a case where the detection value of the temperature is in the predetermined range of temperature (YES at S112), the temperature/humidity control portion 21 transmits an instruction to operate the fan 35 or does not transmit the instruction when the fan 35 operates continuously.

The temperature/humidity determination portion 22 further determines whether or not the detection value of the humidity is in a predetermined range of humidity (S116). In a case where the detection value of the humidity exceeds the predetermined range of humidity (NO at S116), the temperature/humidity control portion 21 instructs the air-conditioning unit 30 to adjust the humidity, and the air-conditioning unit 30 causes the humidity adjustment portion 34 to operate and thereby adjusts the humidity to be in the predetermined range of humidity (S118). Note that, in a case where the detection value of the humidity is in the predetermined range of humidity (YES at S116), the temperature/humidity control portion 21 transmits an instruction to operate the fan 35 or does not transmit the instruction when the fan 35 operates continuously. Thereby, the air that has flowed into the air-conditioning unit 30 from the flow path b becomes the air the CO₂ concentration, the temperature, and the humidity of which are adjusted and is discharged from the fan 35 to the flow path c. Then, the air passes through the flow path c and is returned to the inside of the room. Note that, the control unit 20 resets the timer (S120) after giving the control instructions to the air-conditioning unit 30 and the CO₂ absorbing unit 40, and, when the timer reaches the predetermined time again, processing at and after S100 is performed repeatedly.

Note that, processing from S102 to S108 and processing from S110 and S118 may be performed in parallel or in an order opposite to the above-described order. Moreover, by opening/closing a movable valve of the outside air flow rate controller 61 in accordance with the detection values of the temperature/humidity detection portion 12 and the CO₂ concentration detection portion 13, the control unit 20 may send, to the flow path b, the air in the inside of the room, which has passed through the flow path a, and the outside air in a mixed manner. It is thereby possible to adjust the CO₂ concentration, the temperature, and the humidity while ventilating the inside of the room. Further, without transmitting the measurement time to the control unit 20, the timer 11 may directly instruct the temperature/humidity detection portion 12 and the CO₂ concentration detection portion 13 to perform the detection, when the measurement time reaches the predetermined time.

With the processing above, the air-conditioning system 100 is able to control an inflow of the air to the flow path d separately from an inflow of the air to the air-conditioning unit 30. Thus, it is possible to control the inflow so that CO₂ absorbing efficiency of the CO₂ absorbing portion 50 becomes optimum. Moreover, when it is not necessary to absorb CO₂, the air does not pass through the CO₂ absorbing portion 50, so that it is possible to make a period during which the CO₂ absorbing pellet 52 inside the CO₂ absorbing portion 50 is able to absorb CO₂ much longer. Furthermore, since the period is made longer, it is possible to suppress costs and energy related to replacement or regeneration of the CO₂ absorbing member.

Moreover, with the aforementioned processing, since it is possible to control CO₂ concentration in a space without ventilation, it is possible to prevent a bad influence on a human body according to an increase in the CO₂ concentration, while preventing a foul smell, pollen, a hazardous material in the atmosphere (such as PM 2.5) from flowing into the space. Additionally, since ventilation is not performed, it is possible to reduce an air-conditioning loss at a time of ventilation.

Note that, although the air-conditioning unit 30 has a function of adjusting the temperature and the humidity in the present embodiment, the air-conditioning unit 30 is only required to be able to adjust at least one of the temperature and the humidity. For example, in a case where the air-conditioning unit 30 adjusts only the temperature of the air, the temperature/humidity detection portion 12 is required to detect only the temperature and the temperature/humidity determination portion 22 is required to perform only determination processing related to the temperature. Then, the temperature/humidity control portion 21 is only required to instruct the air-conditioning unit 30 to adjust the temperature. On the contrary, for example, in a case where the air-conditioning unit 30 controls only the humidity of the air, the temperature/humidity detection portion 12 is required to detect only the humidity and the temperature/humidity determination portion 22 is required to perform only determination processing related to the humidity. Then, the temperature/humidity control portion 21 is only required to instruct the air-conditioning unit 30 to adjust the humidity.

### Embodiment 2

In the invention, the CO₂ absorbing portion 50 may be provided with a regeneration mechanism for regenerating the CO₂ absorbing pellet 52 (restoring a CO₂ absorbing ability of the absorbing pellet 52). Hereinafter, Embodiment 2 of the invention will be described. Note that, for convenience of description, description of members having the same functions as those of the members described in the embodiment above will be omitted.

The air-conditioning system 100 according to the present embodiment is different from the air-conditioning system 100 according to Embodiment 1 in that the regeneration mechanism for regenerating the CO₂ absorbing pellet 52 in the CO₂ absorbing portion 50 is provided. The regeneration mechanism is appropriately designed in accordance with a property of the CO₂ absorbing pellet 52. The property of the CO₂ absorbing pellet 52 and a configuration of the regeneration mechanism will be described below with a specific example.

A lithium composite oxide such as Li₂ZrO₃, LiFeO₂, LiNiO₂, Li₂TiO₃, Li₂SiO₃, or Li₄SiO₄ has a property of absorbing CO₂ at a predetermined temperature or below and emitting CO₂, which has been absorbed and held, when temperature becomes higher than the predetermined one. In a case where a material having such a property is used as the CO₂ absorbing pellet 52, a heater for heating the CO₂ absorbing pellet 52 (or the filter cover 51 that holds the CO₂ absorbing pellet 52) or a waste heat supply portion for supplying, to the CO₂ absorbing pellet 52, waste heat, such as waste heat of the air-conditioning unit 30, which is generated in the air-conditioning system 100 or in the inside of the room or in the outside of the room is provided as the regeneration mechanism. On the other hand, in a case where a material that emits absorbed CO₂ in accordance with a change in pressure is used as the CO₂ absorbing pellet 52, a fan that is able to set pressure in the inside of the filter cover 51 to be negative by operating is provided as the regeneration mechanism.

Then, the CO₂ absorbing unit 40 operates the regeneration mechanism in response to an instruction from the control unit 20 to thereby refresh the CO₂ absorbing pellet 52 of CO₂ absorbing portion 50. For example, in a case where the detection value of the CO₂ concentration detection portion 13 is less than predetermined CO₂ concentration, that is, in a case where it is not necessary to adjust the CO₂ concentration at the present time, the CO₂ concentration control portion 25 may instruct the CO₂ absorbing unit 40 to operate the regeneration mechanism. Alternatively, the CO₂ absorbing unit 40 may operate the regeneration mechanism to discharge CO₂ without depending on an instruction of the control unit 20, in a case where an amount of CO₂ absorbed by the CO₂ absorbing pellet 52 becomes equal to or more than a fixed amount, that is, in a case where it is estimated that the CO₂ absorbing ability of the CO₂ absorbing pellet 52 is deteriorated. Note that, the amount of CO₂ absorbed by the CO₂ absorbing pellet 52 is able to be obtained by subtracting a weight of the CO₂ absorbing pellet 52 before use from a current weight (after the use).

Moreover, CO₂ emitted from the CO₂ absorbing pellet 52 due to the function of any of the above-described regeneration mechanisms is only required to be discharged to the outside of the room without being mixed with the air in the flow paths a to d. In addition, it is desired that, when operating the regeneration mechanism, the CO₂ absorbing unit 40 closes the movable valves of the introduced air volume controller 41 and the discharged air volume controller 42 so that the air does not pass through the CO₂ absorbing portion 50 (that is, the air does not flow into the flow path d1 nor d2 in FIG. 2).

With the processing above, by refreshing the CO₂ absorbing pellet 52 as appropriate, the air-conditioning system 100 is able to utilize the CO₂ absorbing pellet 52 for a longer period. Moreover, it is possible to make the best use of the CO₂ absorbing ability of the CO₂ absorbing pellet 52. Accordingly, an effect that replacement of the CO₂ absorbing pellet 52 is not required or replacement frequency is lowered achieved.

Note that, instead of instructing the CO₂ absorbing unit 40 to cause the regeneration mechanism to operate for the CO₂ absorbing pellet 52, the control unit 20 may notify a user to refresh the CO₂ absorbing pellet 52, and cause the CO₂ absorbing unit 40 to operate the regeneration mechanism in a case where the user performs, via an input device (not illustrated) or the like, an operation to instruct the refreshment.

As above, with the configuration according to the present embodiment, the air-conditioning system 100 is able to regenerate the CO₂ absorbing pellet 52. Particularly in a case where it is not necessary to adjust CO₂ concentration in the air at the present time or in a case where the CO₂ absorbing ability of the CO₂ absorbing pellet 52 is deteriorated, by causing the regeneration mechanism to operate and regenerating the CO₂ absorbing pellet 52, it is possible to make a period during which the CO₂ absorbing pellet 52 is able to absorb CO₂ longer and reduce costs or a loss of energy related to replacement of the CO₂ absorbing pellet 52.

### Embodiment 3

In the invention, in addition to absorbing CO₂ in the air by the CO₂ absorbing portion 50, the CO₂ absorbing unit 40 may be further configured to be able to add CO₂ to the air. Hereinafter, Embodiment 3 of the invention will be described.

The air-conditioning system 100 according to the present embodiment is different from the air-conditioning system 100 according to Embodiment 1 in that the CO₂ absorbing portion 50 is provided with an emission mechanism for emitting CO₂ from the CO₂ absorbing pellet 52 into the air. Note that, similarly to the regeneration mechanism in Embodiment 2, the emission mechanism is only required to be designed in accordance with a property of the CO₂ absorbing pellet 52.

In the present embodiment, the CO₂ concentration determination portion 26 of the CO₂ concentration control portion 25 determines whether or not the detection value of the CO₂ concentration detection portion 13 is in a predetermined range of CO₂ concentration (predetermined range). In a case where the detection value is greater than the predetermined range of CO₂ concentration, the CO₂ concentration control portion 25 instructs the CO₂ absorbing unit 40 to absorb CO₂ in the air. This processing is similar to the processing described in Embodiment 1. On the other hand, in a case where the detection value is lower than the predetermined range of CO₂ concentration (falls below the predetermined range), the CO₂ concentration control portion 25 instructs the CO₂ absorbing unit 40 to add CO₂ to the air. When receiving the instruction, the CO₂ absorbing unit 40 opens the movable valves of the introduced air volume controller 41 and the discharged air volume controller 42 to take the air into the flow path d and causes the emission mechanism to operate. Thereby, CO₂ increases in the air inside the filter cover 51 of the CO₂ absorbing portion 50, so that the air that has passed through the CO₂ absorbing portion 50 becomes the air to which CO₂ is added.

When CO₂ concentration in the air becomes equal to or greater than a predetermined concentration (for example, 1000 ppm), there is a risk of injuring human health. However, for human health, it is also not preferable that the CO₂ concentration in the air is decreased too much. For example, when CO₂ in the air becomes insufficient, there is a possibility that blood of a person who inhales the air is alkalized and the person loses consciousness or is convulsed. Therefore, in order to maintain the CO₂ concentration in the air to be appropriate concentration, it is preferable to control the CO₂ concentration by setting not only an upper limit of the CO₂ concentration in the air but also a lower limit. Thus, it is preferable that the above-described “predetermined range of CO₂ concentration” is CO₂ concentration in a range that does not give a bad influence on a human body.

Here, with the configuration according to the present embodiment, the air-conditioning system 100 is able to set CO₂ concentration in the air within the predetermined range or make it closer to the predetermined range. Thus, with the configuration according to the present embodiment, in a case where CO₂ concentration in the air is decreased to such a degree that human health is injured, by adding CO₂ to the air that flows through the CO₂ absorbing portion, it is possible to maintain the CO₂ concentration in the air to be an appropriate value.

### Embodiment 4

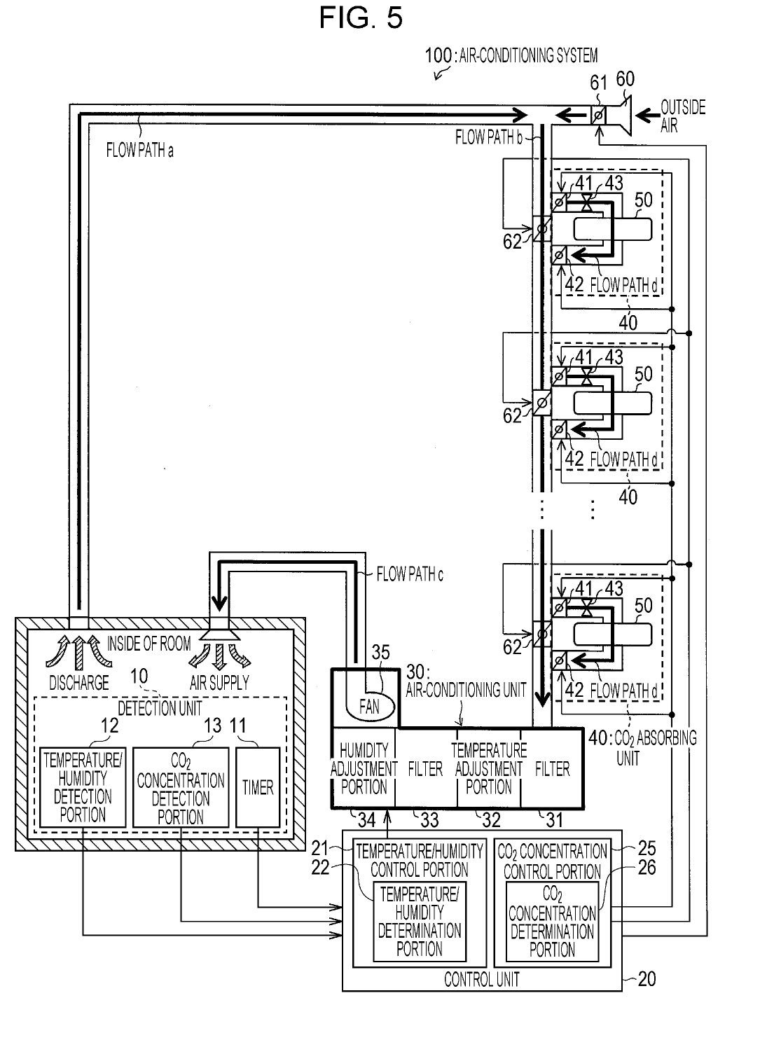

Further, in the invention, the air-conditioning system 100 may be provided with a combination of the branching flow rate controller 62 and the CO₂ absorbing unit 40 which are illustrated in FIG. 1 at each of a plurality of places. FIG. 5 illustrates another example of the configuration of the air-conditioning system 100. In the air-conditioning system 100 illustrated in FIG. 5, the combinations are provided at two or more places in the middle of the flow path b. Note that, the combinations may be provided at one or more places in the flow path b and one or more places in the flow path c in a form similar to that in the flow path b.

Furthermore, the control unit 20 may decide to how many CO₂ absorbing units 40 among the plurality of CO₂ absorbing units 40 the air is introduced (in how many CO₂ absorbing units 40 the movable valves of the outside air flow rate controller 61 and the branching flow rate controller 62 are opened) and transmit an individual instruction to each of the CO₂ absorbing units 40. Thereby, the air-conditioning system 100 is able to more freely control air volume that passes through the CO₂ absorbing unit 40 (the CO₂ absorbing portion 50 included in the CO₂ absorbing unit 40), and is thereby able to more correctly control CO₂ concentration in the air.

Moreover, in a case where the CO₂ absorbing portion 50 is provided with the regeneration mechanism described in Embodiment 2, while refreshing the CO₂ absorbing pellet 52 in one CO₂ absorbing unit 40, it is possible to absorb CO₂ in a different CO₂ absorbing unit 40. Thus, there is an advantage to be able to continuously control the CO₂ concentration in the air.

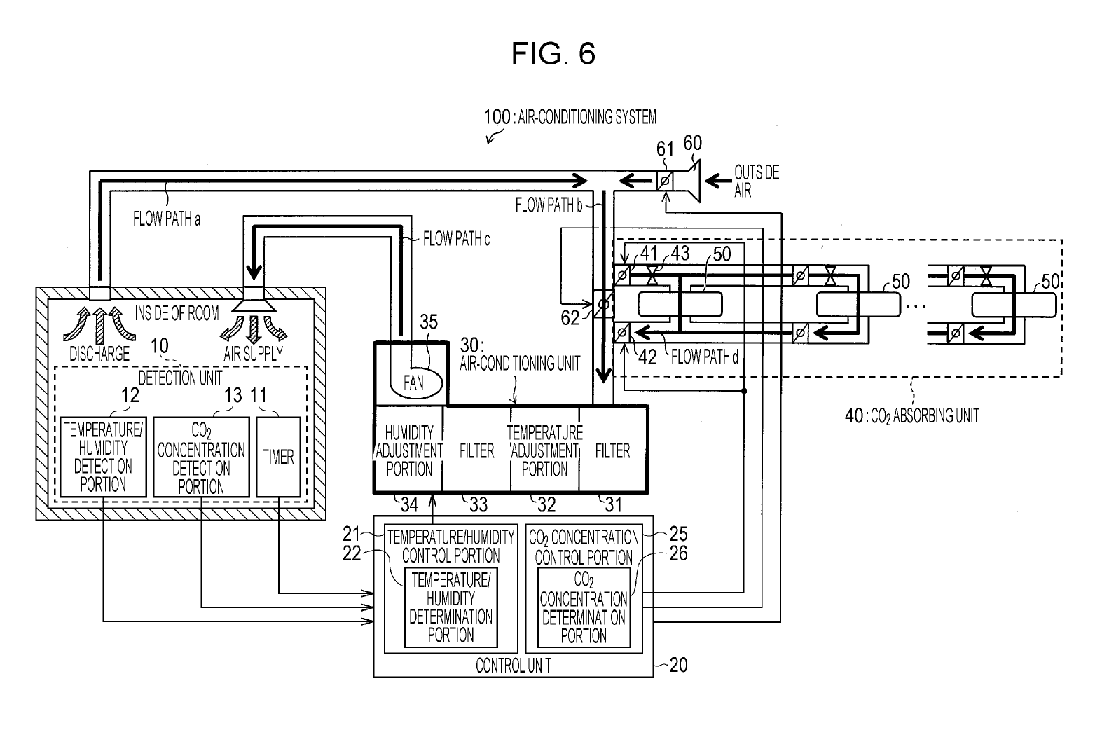

Further, a plurality of CO₂ absorbing portions 50 may be provided in an inside of one CO₂ absorbing unit 40. FIG. 6 illustrates still another example of the configuration of the air-conditioning system 100. The CO₂ absorbing unit 40 of FIG. 6 includes a plurality of CO₂ absorbing portions 50. In a case where the CO₂ absorbing unit 40 includes the plurality of CO₂ absorbing portions 50 in this manner, the air passes through the plurality of CO₂ absorbing portions 50, and it is therefore possible to absorb more CO₂ in the air. Note that, it may be possible to control, by movable valves provided in the flow path d and an instruction from the control unit 20, how many CO₂ absorbing portions 50 among the plurality of CO₂ absorbing portions 50 the air is caused to pass through. For example, in a case where the CO₂ concentration is extremely great, for example, as much as 3000 ppm, the air introduced to the flow path d may pass through all of the CO₂ absorbing portions 50. On the other hand, in a case where the CO₂ concentration is slightly greater than predetermined concentration (for example, 1100 ppm or the like), the air introduced to the flow path d may pass through only a part of the CO₂ absorbing portions 50.

Also in this case, when the regeneration mechanism described in Embodiment 2 is provided in each of the CO₂ absorbing portions 50, while refreshing the CO₂ absorbing pellet 52 in one CO₂ absorbing unit 40, it is possible to absorb CO₂ in a different CO₂ absorbing unit 40. Thus, there is an advantage to be able to continuously control the CO₂ concentration the air.

### [Implementation Example by Software]

A control block of the control unit 20 (the temperature/humidity control portion 21 and the CO₂ concentration control portion 25) may be implemented by a logic circuit (hardware) formed on, for example, an integrated circuit (IC chip) or may be implemented by software by using a CPU (Central Processing Unit).

In the latter case, the control unit 20 includes: a CPU for executing commands of a program which is software for implementing each function; a ROM (Read Only Memory) or a storage device (each of which is referred to as a “recording medium”) in which the program and various kinds of data are recorded so as to be readable by a computer (or the CPU); a RAM (Random Access Memory) for expanding the program; and the like. Then, the object of the invention is achieved when the computer (or the CPU) reads the program from the recording medium and executes it. As the recording medium, a “tangible medium which is not temporary” such as, for example, a tape, a disk, a card, a semiconductor memory, or a programmable logical circuit can be used. Furthermore, the program may be supplied to the computer via any transmission medium capable of transmitting the program (such as a communication network or a broadcast wave). Note that, the invention is also able to be implemented in a form of a data signal embedded in a carrier wave in which the program is embodied by electronic transmission.

### CONCLUSION

An air-conditioning system (100) according to an aspect 1 of the invention is an air-conditioning system that includes an air-conditioning unit (30) that adjusts at least one of temperature and humidity in air, a first flow path (the flow path a and the flow path b) through which air in a space (inside of a room) is introduced to the air-conditioning unit, and a second flow path (flow path c) through which air discharged from the air-conditioning unit is introduced to the space, including: a CO₂ concentration detection portion (13) that detects CO₂ concentration of the air in the space; a CO₂ absorbing unit (40) that absorbs CO₂ from air which has been taken via the first flow path or the second flow path and thereafter discharges the air to the flow path via which the air has been taken; and a flow rate control portion (CO₂ concentration control portion 25) that adjusts, in accordance with the CO₂ concentration detected by the CO₂ concentration detection portion, an amount of air to be taken into the CO₂ absorbing unit.

With the aforementioned configuration, the CO₂ absorbing unit takes, via the first flow path or the second flow path, air of the amount (flow rate) according to the CO₂ concentration detected by the CO₂ concentration detection portion, absorbs CO₂ from the taken air, and discharges the air after the absorption to the flow path via which the air is taken. Accordingly, it is possible to adjust, in accordance with the CO₂ concentration of the air in the space, CO₂ concentration of the air that passes through the second flow path and is returned to the inside of the room. Moreover, with the aforementioned configuration, a flow rate of the air that passes through the CO₂ absorbing unit is able to be controlled separately from an amount of the air that flows in the first flow path and the second flow path (that is, a flow rate of the air that passes through the air-conditioning unit). Thus, in a space, it is possible to appropriately adjust at least one of temperature and humidity of the air and adjust CO₂ concentration in the air to an appropriate value.

In the air-conditioning system according to an aspect 2 of the invention, in the aspect 1, the flow rate control portion controls the CO₂ absorbing unit so that the air is taken into the CO₂ absorbing unit, in a case where the CO₂ concentration is equal to or greater than predetermined concentration

Here, the “predetermined concentration” is an upper limit of the CO₂ concentration that does not give a bad influence on a human body, for example. With the aforementioned configuration, in a case where the CO₂ concentration becomes equal to or greater than the predetermined concentration, that is, in a case where it is necessary to absorb CO₂ in the air, the flow rate control portion causes the air to flow into the CO₂ absorbing unit. In this manner, CO₂ absorption is performed by the CO₂ absorbing unit as necessary, so that, in addition to being able to appropriately control the CO₂ concentration in the air, it is possible to make a period, during which a CO₂ absorbing member is able to be absorbed, much longer. It is therefore possible to suppress costs and energy related to replacement or regeneration of the CO₂ absorbing member.

In the air-conditioning system according to an aspect 3 of the invention, in the aspect 1 or 2, the CO₂ absorbing unit includes a CO₂ absorbing portion (50) that contains a CO₂ absorbing member (CO₂ absorbing pellet 52) absorbing CO₂ in air, a third flow path (flow path d1) through which all or a part of air flowing in the first flow path or the second flow path is introduced to an inside of the CO₂ absorbing portion, and a fourth flow path (flow path d2) through which air discharged from the CO₂ absorbing portion is discharged downstream with respect to a connection part of the third flow path in the first flow path or the second flow path, and the flow rate control portion controls, in accordance with the CO₂ concentration, an amount of air that flows in the third flow path and the fourth flow path of the CO₂ absorbing unit.

With the aforementioned configuration, in accordance with the CO₂ concentration of the air in the space, all or a part of the air is introduced to the CO₂ absorbing unit via the third flow path and passes through the Co₂ absorbing portion. At this time, CO₂ is absorbed from the passing air by the CO₂ absorbing member. Then, the air discharged from the CO₂ absorbing portion, that is, the air in which CO₂ has been absorbed is returned again to the first flow path or the second flow path via the fourth flow path.

In other words, the air-conditioning system includes a flow path of the air, which passes through the CO₂ absorbing unit, as the flow paths (the third flow path and the fourth flow path) which are branched from a flow path passing through the air-conditioning unit. Thus, the air-conditioning system is able to control a flow rate of the air passing through the air-conditioning unit and a flow rate of the air passing through the CO₂ absorbing unit separately.

In the air-conditioning system according to an aspect 4 of the invention, in the aspect 3, each of the third flow path and the fourth flow path is provided with a movable valve (the introduced air volume controller 41 and the discharged air volume controller 42) at a branch point of the flow path and the first flow path or the second flow path, and the flow rate control portion controls an opening area of the movable valve of each of the third flow path and the fourth flow path in accordance with the CO₂ concentration.

With the aforementioned configuration, the flow rate control portion is able to control, in accordance with the CO₂ concentration in the air, an amount of the air flowing in the third flow path and the fourth flow path. For example, in a case where the CO₂ concentration in the air is significantly greater than the predetermined concentration and it is necessary to promptly decrease the CO₂ concentration, the flow rate control portion performs control so that the opening area of the movable valve of each of the third flow path and the fourth flow path becomes the maximum. Thereby, the air in the first flow path or the second flow path flows into the third flow path and is discharged from the fourth flow path at a maximum, and absorbing of CO₂ by the CO₂ absorbing portion is performed at a maximum. On the other hand, in a case where the CO₂ concentration in the air is slightly greater than the predetermined concentration, by setting the opening area to be smaller than the maximum area, the flow rate control portion is able to restrict an amount of the air that flows into the third flow path (and is discharged from the fourth flow path). This makes it possible to prevent the CO₂ in the air from being excessively absorbed.

In the air-conditioning system according to an aspect 5 of the invention, in the aspect 3 or 4, the CO₂ absorbing unit includes a regeneration mechanism that restores a CO₂ absorbing ability of the CO₂ absorbing member, and the flow rate control portion causes the regeneration mechanism to operate, in a case where the CO₂ concentration is less than predetermined concentration.

Here, the “predetermined concentration” is an upper limit of the CO₂ concentration that does not give a bad influence on a human body, for example. Accordingly, with the aforementioned configuration, in a case where the CO₂ concentration the air is concentration of such a degree that a bad influence is not given to a human body, that is, in a case where it is not necessary to adjust the CO₂ concentration the air at the present time, the regeneration mechanism is caused to operate, and the CO₂ absorbing ability of the CO₂ absorbing member is restored. Thereby, it is possible to make a period during which the CO₂ absorbing member is able to absorb CO₂ much longer. It is therefore possible to reduce costs or a loss of energy related to replacement of the CO₂ absorbing member.

In the air-conditioning system according to an aspect 6 of the invention, in the aspect 3 or 4, the CO₂ absorbing unit includes an emission mechanism that emits, to air, CO₂ absorbed by the CO₂ absorbing member, and the flow rate control portion controls the CO₂ absorbing unit so that air flows through the third flow path and the fourth flow path, in a case where the CO₂ concentration is not in a predetermined range, and further causes the emission mechanism to operate, in a case where the CO₂ concentration falls below the predetermined range.

Here, the predetermined range indicates a range of CO₂ concentration that does not give a bad influence on a human body, for example. Accordingly, with the aforementioned configuration, in a case where the CO₂ concentration in the air is decreased to such a degree that human health is injured, by adding CO₂ to the air that flows through the CO₂ absorbing portion, it is possible to maintain the CO₂ concentration in the air to be an appropriate value.

The air-conditioning system according to an aspect 7 of the invention includes, in any one aspect of the aspects 2 to 6, a plurality of CO₂ absorbing units, each of which is the CO₂ absorbing unit that absorbs CO₂, in which the flow rate control portion controls, in accordance with the CO₂ concentration, an amount of air to be taken into each of the CO₂ absorbing units.

With the aforementioned configuration, the air-conditioning system is able to freely control each air volume that passes through each of the plurality of CO₂ absorbing portions. Thus, it is possible to more correctly adjust the CO₂ concentration in the air.

A CO₂ absorbing unit according to an aspect 8 of the invention is a CO₂ absorbing unit (40) added to an air-conditioning system (100) including an air-conditioning unit (30) that adjusts at least one of temperature and humidity of air in a space (inside of a room) and discharges the air to the space, including a CO₂ absorbing portion (CO₂ absorbing portion 50) that contains a CO₂ absorbing member (CO₂ absorbing pellet 52) absorbing CO₂ in the air, in which a flow rate of air to be taken into the CO₂ absorbing portion via either a first flow path through which the air in the space is introduced to the air-conditioning unit or a second flow path through which air discharged from the air-conditioning unit is introduced to the space is controlled by a flow rate control portion (CO₂ concentration control portion 25), which is included in the air-conditioning system, in accordance with CO₂ concentration detected by a CO₂ concentration detection portion that is included in the air-conditioning system.

With the aforementioned configuration, an effect similar to that of the air-conditioning system according to the aspect 1 is achieved.

The invention is not limited to each of the embodiments described above and may be modified in various manners within the scope of the claims, and an embodiment achieved by appropriately combining technical means disclosed in different embodiments is also encompassed in the technical scope of the invention. Further, by combining the technical means disclosed in each of the embodiments, a new technical feature may be formed.

### REFERENCE SIGNS LIST

100 air-conditioning system
13 CO₂ concentration detection portion
20 control unit
25 CO₂ concentration control portion (flow rate control portion)
30 air-conditioning unit
40 CO₂ absorbing unit
41 introduced air volume controller
42 discharged air volume controller
50 CO₂ absorbing portion
52 CO₂ absorbing pellet (CO₂ absorbing member)
a, b, c, d, d1, d2 flow path

1. An air-conditioning system that includes an air-conditioning unit that adjusts at least one of temperature and humidity in air, a first flow path through which air in a space is introduced to the air-conditioning unit, and a second flow path through which air discharged from the air-conditioning unit is introduced to the space, comprising:
a CO₂ concentration detection portion that detects CO₂ concentration of the air in the space;
a CO₂ absorbing unit that absorbs CO₂ from air which has been taken via the first flow path or the second flow path and thereafter discharges the air to the flow path via which the air has been taken; and
a flow rate control portion that adjusts, in accordance with the CO₂ concentration detected by the CO₂ concentration detection portion, an amount of air to the taken into the CO₂ absorbing unit,
the air-conditioning system comprising a plurality of CO2 absorbing units, which are provided to the space and each of which is the CO2 absorbing unit that absorbs CO2.

2. The air-conditioning system according to claim 1, wherein the flow rate control portion controls the CO₂ absorbing unit in such a way that the air is taken into the CO₂ absorbing unit, in a case where the CO₂ concentration is equal to or greater than predetermined concentration.

3. The air-conditioning system according to claim 1, wherein
the CO₂ absorbing unit includes
a CO₂ absorbing portion that contains a CO₂ absorbing member absorbing CO₂ in air,
a third flow path through which all or a part of air flowing in the first flow path or the second flow path is introduced to an inside of the CO₂ absorbing portion, and
a fourth flow path through which air discharged from the CO₂ absorbing portion is discharged downstream with respect to a connection part of the third flow path in the first flow path or the second flow path, and
the flow rate control portion controls, in accordance with the CO₂ concentration, an amount of air that flows in the third flow path and the fourth flow path of the CO₂ absorbing unit.

4. The air-conditioning system according to claim 3, wherein
each of the third flow path and the fourth flow path is provided with a movable valve at a branch point of the flow path and the first flow path or the second flow path, and
the flow rate control portion controls an opening area of the movable valve of each of the third flow path and the fourth flow path in accordance with the CO₂ concentration.

5. The air-conditioning system according to claim 3, wherein
the CO₂ absorbing unit includes a regeneration mechanism that restores a CO₂ absorbing ability of the CO₂ absorbing member, and
the flow rate control portion causes the regeneration mechanism to operate, in a case where the CO₂ concentration is less than predetermined concentration.

6. The air-conditioning system according to claim 3, wherein
the CO₂ absorbing unit includes an emission mechanism that emits, to air, CO₂ absorbed by the CO₂ absorbing member, and
the flow rate control portion controls the CO₂ absorbing unit in such a way that air flows through the third flow path and the fourth flow path, in a case where the CO₂ concentration is not in a predetermined range; and further causes the emission mechanism to operate, in a case where the CO₂ concentration falls below the predetermined range.

7. The air-conditioning system according to claim 2, wherein
the flow rate control portion controls, in accordance with the CO₂ concentration, an amount of air to be taken into each of the CO₂ absorbing units.

8. (canceled)
